(19) United States
(12) Patent Application Publication
(10) Pub. No.: US 2012/0076901 A1
(43) Pub. Date: Mar. 29, 2012

(54) Apparatus and method for preserving food and other applications

(76) Inventor: Daniel N. Liss, Silver Spring, MD (US)

(21) Appl. No.: 12/924,557

(22) Filed: Sep. 29, 2010

(51) Int. Cl. A23L 3/3418

(52) U.S. Cl. 426/234; 99/467

(57) ABSTRACT

The invention is a process and apparatus for eliminating most of the oxygen in a closed container by reacting the oxygen with carbon, such as carbon fibers, by electrically heating the carbon fibers until the carbon binds the oxygen into carbon dioxide, thereby removing the oxygen, and replacing the oxygen with carbon dioxide. This is important for preserving foods, certain plants, and other products which deteriorate in the presence of oxygen.

The apparatus and process of the invention have significant economic value over the prior art.

### CROSS REFERENCE TO RELATED APPLICATION

This application claims the benefit of the Provisional Allocation filed on or about Oct. 5, 2009 with the title, APPARATUS AND METHOD FOR PRESERVING FOOD.

### BACKGROUND OF THE INVENTION

The problem of preserving food and other products such as flowers and the like is an issue confronting commercial companies and consumers everyday. It is common to store foods in refrigerators and freezers to extend the useful life of food; however, the food deteriorates and spoils despite these measures. It is common to add chemicals as additional preservatives to foods, but this adds costs and many people have an aversion to added chemicals.

One of the sources responsible for spoiling food is the presence of oxygen. Both commercial companies and consumers approach the reduction of oxygen in contact with packaged food by reducing, or effectively removing most of the air in the package. This can be a problem because some foods in a low pressure environment can lose components such as low density oils, thereby changing the taste of the food being preserved. In addition, processes that aim to remove air physically from packages can be expensive and/or inconvenient to implement. Often products being stored can be crushed by such processes, or sharp edges of products can puncture through package wrappings.

Innovative processes for preserving foods such as meats in commercial processing include injecting gases such as nitrogen and carbon dioxide to lower the oxygen level within a package by displacing air, thereby effectively reducing the oxygen content. This approach avoids a reduced pressure which might harm the taste of the food. Additionally, the gasses used to displace air inside these packages can have bacteria-reducing properties which further help to preserve foods. A similar approach for displacing air is taken for other products such as flowers.

There is a need for an apparatus and method, suitable for both commercial and consumer use, which preserve food easily by replacing much of the oxygen in a package of food or other products with a gas such as carbon dioxide which will not harm the taste or quality of the food or product.

### SUMMARY OF THE INVENTION

In one embodiment, the invention relates to an apparatus comprising enclosure means operable to enclose air and a substance such as a food to be preserved, electrical terminal means operable for being connected to a voltage source and having a first portion extending into the enclosure means and having a second portion extending outside the enclosure, and holding means electrically connected to the electrical terminal means and operable for holding a material capable of oxidizing to create carbon dioxide, whereby the enclosure means can be relatively sealed against gases and the material can be oxidized by applying sufficient heat through electrical power to the electrical terminal means to the material, thereby reacting the oxygen within the enclosure means with the material and creating carbon dioxide. The enclosure means need not have a complete seal against gases for all applications of the invention; however, it is preferable to have a relatively air tight seal for many applications of the invention. The extent of the sealing needed for a particular application of the invention can be determined experimentally.

In another embodiment, the invention relates to a method of enclosing a substance to be preserved in an enclosure relatively sealed against gases, and enabling a carbon substance within the enclosure to burn so that the oxygen in the enclosure is reacted to produce carbon dioxide.

It is convenient to use commercially available carbon fiber, or relatively thin carbon rods, or the like to be burned within the enclosure. The goal is to burn the carbon fiber or carbon rod so the amount of electrical current needed to initiate the oxidation of the carbon depends on the electrical resistance; hence, the diameter of the carbon is an important factor and a preferable effective diameter of the carbon can be determined experimentally.

The commercially available carbon fibers are similar in appearance to a bundle of thread and are electrically conductive. Passing electrical current through the carbon fibers can cause the carbon fibers to heat due to electrical resistance and sufficient heat results in the carbon to burn, create carbon dioxide. The electrical current needed to initiate the burning is relatively high, but it is for a very short time. The onset of burning is easily observable, and it can be determined experimentally.

The minimum amount of carbon needed to be burned to consume the oxygen within the enclosure can be calculated using well known chemistry principles. It is not necessary to use the minimum. It is, however, wasteful to exceed the minimum greatly due to the extra carbon and the required electrical power needed. Simple experimentation can be carried out to determine a suitable combination of carbon and electrical power to achieve the goal of chemically binding most of the oxygen with the carbon to form carbon dioxide and achieve a suitable reduction of local oxygen.

### BRIEF DESCRIPTION OF THE DRAWINGS

FIG. 1 shows a perspective view of first embodiment of the invention connected to an electrical power source.

FIG. 2 shows a perspective view of the embodiment shown in FIG. 1 with the cover open.

FIG. 3 shows a perspective view of a second embodiment of the invention.

FIG. 4 shows a perspective view of an embodiment of a portion of the invention.

FIG. 5 shows a plan view of another embodiment of a portion of the invention.

FIG. 6 shows a perspective view of a yet another embodiment of a portion of the invention.

FIG. 7 shows a perspective view of a third embodiment of the invention.

FIG. 8 shows a perspective view of a fourth embodiment of the invention.

FIG. 9 shows the electrical circuit used in the embodiment of FIG. 8.

FIG. 10 shows a perspective of another portion of the invention.

FIG. 11 shows the embodiment shown in FIG. 8 used with the embodiment shown in FIG. 1

FIG. 12 shows an exploded sectional view of a fifth embodiment of the invention.

FIGS. 13, 14, and 15 show plan views of three components used together to carry out the invention in a fifth embodiment.

FIG. 16 shows a side elevational view of a sixth embodiment of the invention.

FIG. 17 is a perspective view of the invention showing some details in the construction.

FIG. 18 is a block diagram of yet another embodiment of the invention.

FIG. 19 is a representative view with a portion removed to show the interior of a simple portable embodiment of the invention for convenient use in containers without any special arrangement.

### DESCRIPTION OF THE INVENTION

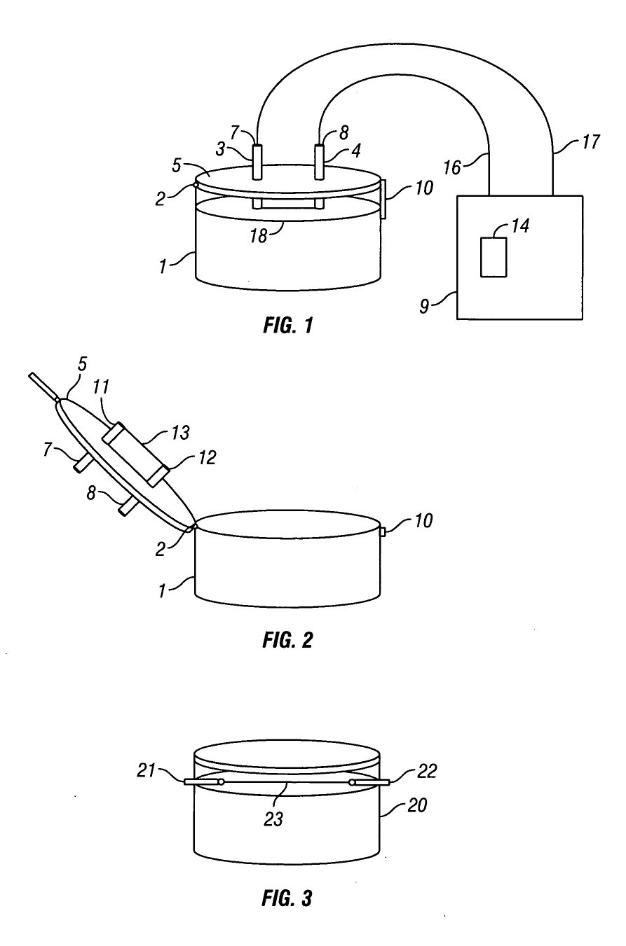

In FIG. 1, a container 1 is used. It is convenient to use a container 1 made from non-electrically conducting material such as plastic, but a metal container 1 could be used. Container 1 should be able to close tightly and be relatively resistive to gases moving in or out; however, it may not be necessary to have a tightly closed container 1 for all applications of the invention. The degree of the enclosure to resist movement of gases in, or out depends on the intended application of the invention and can be determined experimentally. Typically, a container 1 with a good air seal such as used conventionally for food is suitable, although a strong seal against air entering the closed container 1 is preferable.

The container 1 is shown as being cylindrical, but other shapes may be used. It is not believed that a cylindrical shape has significant advantages over containers with different shapes such as a shape like a box although the interior air might move better towards a burning carbon in a cylindrical or spherical shaped container 1.

Container 1 has a hinge 2 and FIG. 2 shows the container 1 in its open position. Electrodes 3 and 4 pass though cover 5 with a preferably air tight seal and have outer ends 7 and 8 suitable to be connected to an electrical power source 9. The degree of the seal for the electrodes 3 and 4 can be determined experimentally. If the container 1 were made from an electrically conducting material such as metal, then insulation around the electrodes 3 and 4 would be needed to prevent the electrical path between the electrodes 3 and 4 being through the metal container 1. Alternatively, the electrodes 7 and 8 can communicate electrical power from outside the container 1 to its interior without passing through the container 1 using microwaves, or capacitance, or other known ways for transferring electrical power from outside to inside the container 1. Locking mechanism 10 is used to hold the cover 5 in a closed position. The electrodes 3 and 4 have ends 11 and 12 which have mechanisms to hold a carbon fiber 13. For testing the invention, it was convenient to mount the electrodes 3 and 4 so that the fiber 13 was relatively horizontal, but the orientation of the fiber 13 is not apparently important so other orientations may be used for the convenience of the application of the invention.

Closure of switch 14 causes an electrical voltage to go from electrical power source 9 though wires 16 and 17 to electrodes 3 and 4 through carbon fiber or carbon fibers 13. Sufficient electrical power causes the carbon fiber 13 to ignite and burn to consume oxygen and produce carbon dioxide. A device 18 can be used to allow air in the container 1 to move freely to the carbon fiber 13, and prevent pieces of the burnt carbon fiber 13 from falling onto food that might be placed at the bottom of the container 1.

FIG. 3 shows a container 20 which is an embodiment essentially the same as container 1 with the difference being that electrodes 21 and 22 are at the side of the container 20 and a carbon fiber 23 extends across between electrodes 21 an 22.

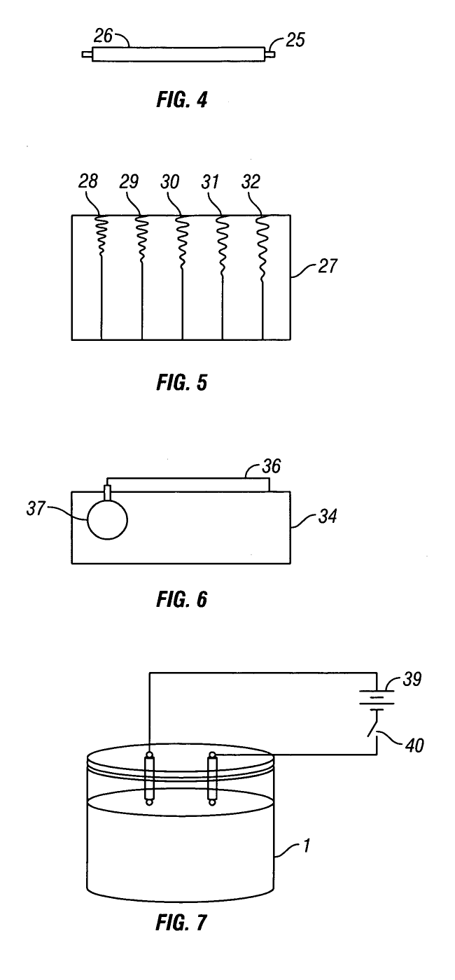

FIG. 4 shows an embodiment for using a carbon fiber 25 in a holder 26. The holder 26 is a non-conductive material which preferably does not burn when the carbon fiber 26 burns.

FIG. 5. shows a plan view of a holder 27 for a set of carbon fibers 28-32. Instead of using separate pieces of carbon fiber or fibers 13 such as shown in FIGS. 1 and 3, a holder 27 can be used and the operator of the might decide to use the unused carbon fiber or fibers from a previous employment of the invention.

FIG. 6 shows a sectional view of a cartridge 34 for carbon fiber or fibers 36. A portion of a roll 37 of the carbon fibers 36 extends across part of the cartridge 34. Connections are made to two portions of the carbon fiber 36 when it is used in the invention. A portion of the carbon fiber 36 consumed by the operation of the invention. Additional carbon fiber 36 is unrolled from the roll 37 for the next use.

FIG. 7 is an embodiment similar to the container 1 shown in FIG. 1, but the electrical source is a battery 39 controlled by a switch 40.

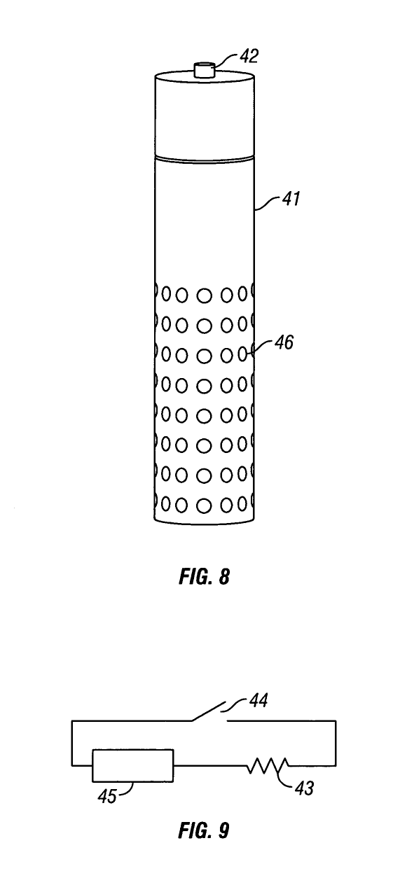

FIG. 8 is another embodiment of the invention in the form of a tubular case 41 containing a carbon fiber holder, a carbon fiber 43, a switch 42, and a battery 45. The electrical circuit for the case 41 is shown in FIG. 9. Case 41 has openings 46 so that the inner chamber holding the carbon fiber 43 can communicate with external air. When the carbon fiber 43 is burned, the carbon fiber 43 uses oxygen inside the case 41 and air from outside the case 41 is available for being consumed.

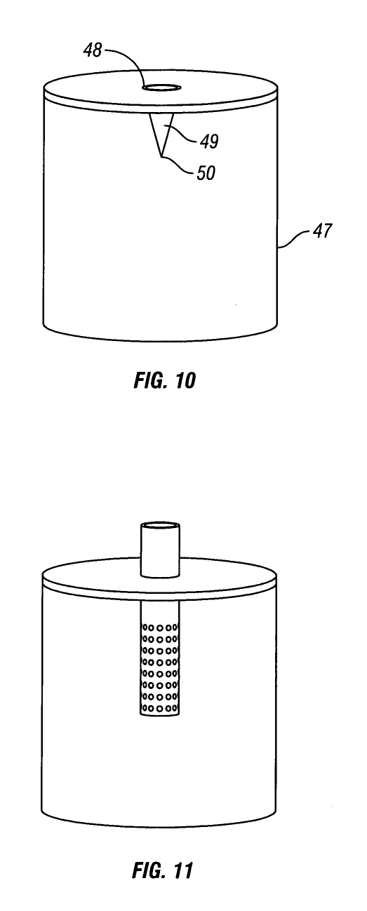

The case 41 can be used with a container 47 shown in FIG. 10 having an opening 48 which has a tube 49 such as a plastic tube 49 having an end portion 50 usually closed. When the case 41 is inserted into the tube 49, it is pushed down so that the portion with the holes 46 can communicate with the interior of the container 47 as shown in FIG. 11. Closing the circuit with switch 42 causes the carbon fiber 43 to reach a temperature to burn and react with oxygen both within and outside the case 41. That is, the oxygen in the container 47 is part of the burning and is replaced by carbon dioxide. Withdrawal of the case 41 is done and the end 50 automatically seals the container 47.

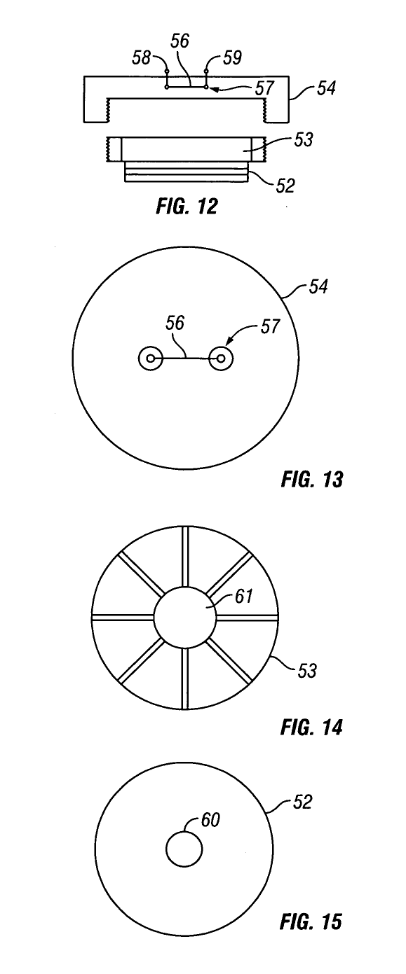

FIG. 12 shows a sectional view of an exploded portion of another embodiment, and reference should be had to FIGS. 13, 14, and 15. The top portion 52 of a container has threads suitable to receive a special cover 53. The special cover 53 has outside threads suitable to receive special cover 54. Special cover 54 contains a carbon fiber 56 being held in a holder 57 having external terminals 58 and 59. The cover 53 fits on the top portion 52. The top portion 52 has an opening 60. The cover 53 can be tightened so that the central portion 61 covers and presses against the opening 60 to form a seal. In operation of the invention, the special cover 54 is used to replace the oxygen with carbon dioxide and then special cover 53 is used to seal the container so that special cover 54 can be removed for use on a different container.

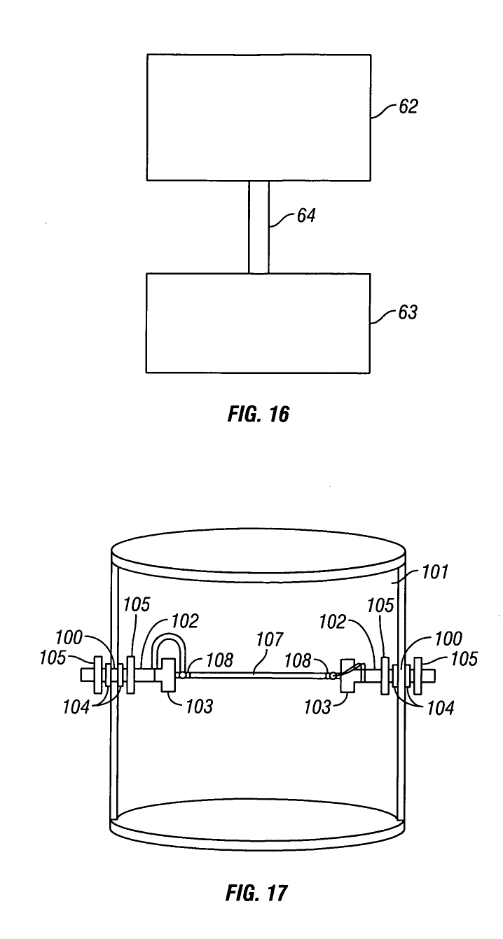

FIG. 16 shows an embodiment in which the box 62 is the system for holding and burning a carbon fiber to replace oxygen with carbon dioxide. Box 63 is a container which is connected by tube 64 for gas communication to box 62 so that when box 62 is operated according to the invention to create carbon dioxide, the oxygen in box 63 is replaced by carbon dioxide. After completing the process of reducing the oxygen in box 63, the tube 64 can be closed with a clamp not shown and cut off above the clamp so that box 62 can be used again for a different box 63 not shown.

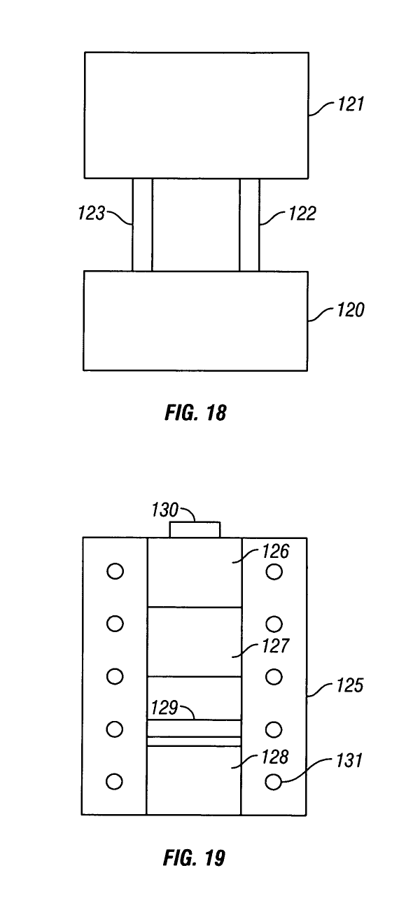

FIG. 18 shows an embodiment of the invention having use for changing an atmosphere such as in a laboratory requiring an atmosphere relatively low in oxygen and relatively high in carbon dioxide. Container 120 could contain a petri dish or some other item. Device 121 pumps air from container 120 through tube 122, and retains the air separate from container 120 while device 121 is activated using the invention to burn carbon (not shown) to transform the oxygen in the device 121 into mostly carbon dioxide. Thereafter, the mixture of air and carbon dioxide in the container 121 is moved through tube 123 into container 120. The lower pressure in the container 120 due to the air being exhausted into the device 121 will move the gases in the device 121 into the container 120. The tubes 122 and 123 need not be separate tubes.

FIG. 19 is an embodiment for a simple device 125 according to the invention suitable for use in containers which have not been adapted for the invention. A portion of the device 125 has been removed to show the interior. The device 125 includes a battery 126, circuitry 127, and a portion 128 having carbon fibers 129. Pressing switch 130 connects the battery 126 to the circuitry 127 after a predetermined time, the battery 126 is connected to the carbon fibers 129 and air entering the openings 131 react with the carbon fibers 129. The device 125 can be used by pressing the switch 130 and placing the device 125 into a container (not shown) and closing the container. The device 125 will thereafter transform most of the oxygen in the container into carbon dioxide.

The device 125 can be made to be reused. If necessary, the battery can be replaced, or recharged, and new carbon fibers 129 can be used.

### Experimental Phase

An 89 mL hermetically sealed container (The Container Store Incorporated, Coppell, Tex.) was adapted for experimentation, so that it utilized the invention. A container of this size was chosen so that it could be easily stored and produced in large quantities; however, the device could have been easily scaled larger. The following aspects of the container were optimized: Varying lengths and numbers of carbon fibers were tested to determine an optimal mass and length for transforming the 89 mL atmosphere within the container, without creating excessive heat. Calculations were performed, which confirmed that the 0.09 g of carbon fibers used in each container was sufficient for transforming the atmosphere.

Different approaches to securing carbon fibers in place were tried to determine a simple yet effective method of keeping the fibers in their correct position within the containers. Carbon fibers were securely held in place between a nut and bolt head screwed tightly into one another other. The other end of the respective bolts extended outside the container to receive electrical current, thereby forming outside terminals.

The duration of the electrical current that was applied to the outside terminals was optimized through trial and error, to ensure a complete transformation of the atmosphere with a minimal amount of generated heat. Electrical current at about 12 volts from an automobile charger was applied to the carbon fibers for about 9 seconds. Carbon fibers were considered completely burned when there was a drop in electrical current (which was read from a meter on the car charger).

The carbon fibers were positioned in different orientations within the containers, in order to optimize the placement within the container, so that the entire container's atmosphere would be transformed. In the orientation ultimately used, carbon fibers were placed horizontally inside the container at about half height of the container.

Silicone rubber sealant was used to improve the gas seals around the bolts penetrating into the containers.

### Construction of the Experimental Device

As shown in FIG. 17, two parallel holes 100 were drilled about halfway between the top and bottom of the container 101. A bolt 102 was fitted through each hole 100, with its head 103 inside the container, facing outward. The bolts 102 were secured, using a washer 104 and a nut 105 on either side of the container wall. Between the two bolts 102, fixed opposite one another, was 6 cm carbon fiber 107 (24000 tow). The carbon fibers 107 were covered on each end by 1 cm of aluminum foil 108. It was held securely in position by the nut 105 and head 103 of each bolt, which were tightly pressed against one another. Silicone rubber sealant was used to seal the container around the holes 100, which were drilled to accommodate the bolts. The container, as purchased, included a rubber ring to form a seal when the container 101 is close. An additional rubber ring was added around each container cover, to improve the hermetic seal.

To activate the carbon fibers 107, the red clip (not shown) from a battery charger (not shown) was attached to one of the protruding bolts, and the black clip (not shown) to the other. With the connections in place, the charger was turned on, and electrical current was delivered to the carbon fibers 107.

In order to test for air leaks in the container 101, each container 101 was closed and submerged in a pot of near-boiling water for 35 seconds. The heat from the water surrounding the container 101 caused the air from within the container 101 to expand. If there were any leaks in a given container 101, bubbles formed around the leaking area(s) of the container 101. Any area(s) found to leak were filled with additional silicone rubber sealant. Once each container 101 was resealed, the seal test was repeated to verify that it was leak proof. All containers 101 were required to pass this seal test before use in the experiment. This was, of course, an indirect test and it presumes that if air cannot leak out, then hopefully, air cannot leak into the container 101.

Three types of containers 101 were used to determine whether the atmosphere within the container 101 prevents growth of spoilage bacteria: hermetically sealed containers activated with the process according to the invention, identical containers not activated with the inventive process, and commercially available reclosable plastic sandwich bags (Presto Products Company, Appleton, Wis.).

0.5 g samples of ground beef (Safeweay, 80% lean) were stored in each of the aforementioned containers for the following lengths of time: no incubation (T0), 1 day (T1), 2 day (T2), 3 days (T3), 6 days (T4), 8 days (T5), 14 days (T6), 18 days (T7), and 32 days (T8). All samples were stored at 4° C. during incubation. Two replicates per time point were processed to increase accuracy and reduce experimental error.

The activated containers 101 were used to verify whether the transformed atmosphere inhibits the growth of spoilage bacteria. The non-activated containers 101 were used as a yardstick for ascertaining how well the transformed atmosphere in the activated containers is preserved over time, and how long the effects of transformed atmosphere last. The plastic bags were use to compare the efficacy of invention to a conventional method of preserving meat.

After each time point, meat samples were removed from their respective containers and photographed. Each sample was subsequently placed in 2 ml of 0.1% bactopeptone water and homogenized using a Tissue Tearor™ homogenizer (Biospec Products Incorporated, Bartlesville, Okla.) for 10 seconds. Homogenates were then vortexed using a Fisher Vortex Genie 2™ (Fisher Scientific, Waltham, Mass. for 45 seconds and centrifuged for 30 seconds in a microfuge (Fisher Scientific, Waltham, Mass.).

Supernatant fluid was used to make decimal dilutions. 0.1 mL from each dilution was then plated on Lysogeny Broth (LB) agar and on Eosine Methylene Blue (EMB) agar. The first medium supports the growth of a large variety of bacteria, while EMB supports the growth of coliforms, which comprise the notorious meat spoilage bacteria. LB agar was used in place of tryptic soy agar, which was not available at the time of experimentation. Media was incubated at 37 C for 18-24 hours. Plaque forming units were counted and expressed as log colony forming units per gram of meat.

Due to observations made on day 6, the procedures were modified from T5 onwards. Samples thereafter were no longer homogenized, and vortex was undertaken for 2 minutes instead of the prior 45 seconds.

### Results

Cost Analysis for device activation
Electricity used in activation=0.00015¢
The applied current had an upper limit of 2 amps. There was an electrical resistance of approximately 1 ohm for the length of 24000 tow carbon fiber used in each device.
An electrical charge was applied for nine seconds to burn the carbon fiber tow. The oxygen was consumed in even fewer seconds, as indicated by a drop in electrical current (which was read from a meter situated on the car charger).

The electrical charge can be estimated by multiplying estimated resistance times estimated electrical current (4 watts). The typical cost for electricity is about 15¢ per kilowatt-hour. The cost of the charge used is 4 watts×1/1000=0.004 kilowatts; 0.004 kilowatts×9/3600=0.00001 kilowatt hour; 0.00001 kilowatt hour×150 per kilowatt hour=0.00015¢.

### b.) Carbon Fiber Usage per Device=0.01311¢

A 250 yard roll of carbon fiber (24000 tow) sells for $49.95 from Fibre Glaste Developments Corporation (Brookeville, Ohio). If one centimeter at this price costs 0.002185¢, then the 6 centimeters used in each container costs 0.01311¢.

### Device Testing

Three types of containers 101 were used to assess the efficacy of meat preservation using the invention: an activated container 101 according to the invention, an identical container 101 where the atmosphere was left unchanged (non-activated container), and a reclosable sandwich sized plastic bag, similar to what may be used in a home setting. Samples of commercially available ground beef (0.5 g) were stored in the aforementioned containers at 4 C for 32 days and microbial analysis was carried out on samples at 9 separate time points, including the initial analysis on day 0. The experiment was conducted in duplicate, so two samples of meat from each type of container were tested at each time point. Average bacterial counts were represented as log (base 10) colony forming units per gram (log CFU/g). Bacterial counts were taken from both LB agar plates, which support a broad range of microflora, and EMB agar plates, which selectively support food spoilage bacteria.

The total bacterial counts in the activated containers dropped by 48% after the first day, from 2.70 log CFU/g to 1.30 log CFU/g, and only reached the 2.70 log CFU/g level again on day 14. Total bacterial counts were lowest at all time points, except on day 32, in meat samples stored in the activated containers. Total counts taken from the non-activated containers and bags between days 0 and 14, rose steadily and at a similar rate. However, counts on day 18 taken from the bags were significantly lower than in the former. By day 32, total bacterial counts taken from all containers were similar.

Food spoilage bacteria counts in the activated containers declined from day 0 to 8, when they reached zero. Counts then remained at zero until day 18, after which they began to rise. Counts taken from the non-activated containers and bags between days 0 and 14, rose steadily and at a similar rate. However, counts on day 18 taken from the bags were significantly lower than in the former. By day 32, food spoilage bacteria counts taken from the activated and non-activated containers were similar, but counts taken from the bags were at zero. Little change in meat texture was observed between day 0 and day 1. By day 6, meat texture in all samples began to change. By day 18, samples stored in bags became extremely pasty. Samples stored in non-activated containers at this time point appeared extremely dry, and samples stored in activated containers appeared dry, but to a lesser extent.

The lyzate prepared from ground beef stored in the bag, on day 8, appeared extremely viscous. The lyzate prepared from ground beef taken from the non-activated container, on the same day, appeared less viscous; while the lyzate prepared with meat taken from the activated containers, on the same day, seemed the least viscous. On day 32, the lyzates all looked comparable, and extremely viscous.

### Discussion and Conclusions

### Analysis of Results

The objective was to isolate the effect, if any, of the inventive process on bacterial growth on ground beef. Ground beef was used in testing, but it is surmised that comparable results would be obtained using other meats or foods because of the way the invention preserves food. The inventive process changes the atmosphere around a food like the industry used modified atmosphere packaging process (MAP), so applications of the invention are expected to be similar to those exhibited by MAP. The invention is expected to inhibit aerobic bacteria, by creating microaerophilic conditions inside a container, and Gram-positive bacteria, by elevating carbon dioxide content to over 10 percent. The majority of significant meat spoilage bacteria are aerobic and/or Gram-positive, so the inventive process was hypothesized to extend shelf life by inhibiting bacterial growth during the 32 days of testing. Based upon the data analyzed in this study, the invention was found to extend shelf life during the first 18 days, but not until 32 days. This indicated that the invention slowed deterioration and spoilage for a substantial, but not an unlimited, length of time.

Samples stored using the invention had the lowest bacterial counts through day 18 on both the LB agar plates, which support a broad range of microflora, and the EMB agar plates, which are selective towards food spoilage bacteria. By day 14, counts of bacteria on samples stored using the invention were at 2.70 log while counts from samples stored in non-activated containers and bags were at 6.37 log and 6.38 log, respectively. This indicates a difference of approximately 3.675 log on day 14, or a 4760 fold reduction in bacteria using the invention.

Bacterial growth on samples stored both in bags and non-activated containers was similar between days 0 and 14; however, growth on the latter appeared more logarithmic. This can be explained by a more consistent packaging of samples stored in the non-activated containers. The samples stored in plastic bags were not always placed at the same spot within the bags, and it is surmised that the plastic bags were not produced with the same degree of quality control as the non-activated containers.

LB bacterial counts in non-activated containers and bags between days 14 and 32 dropped 3.17 log and 3.44 log, respectively. This suggests that, between days 14 and 32, nutrients from meat stored in these containers were depleted, and as a result bacteria on these samples died off. Between days 14 and 18, bacterial growth in the non-activated containers started to level off, only increasing by 0.08 log. However, bacterial growth during the same period of time in the plastic bags plummeted by 3.3 log. It is believed that this difference arose because nutrients in samples stored in the plastic bags were depleted a couple of days before nutrients in samples stored in non-activated containers. This could indicate that bacteria grew faster on meat stored in the plastic bags than in non-activated containers.

Bacterial counts in all three containers were similar on day 32. This indicates that benefits of the invention did not last until day 32. The invention likely delays or slows bacterial growth; however, results indicate that invention does not completely eliminate it. The activated containers actually had the highest bacterial counts at this time point. This might have been because bacterial growth in the plastic bag and non-activated containers had already been depleted of nutrients by this time. However, growth on samples stored in the activated containers was still on the rise.

LB bacterial counts on ground beef stored using invention rose consistently throughout the experiment but decreased between days 0 and 1, and between days 3 and 8. The first decrease of 1.4 log was likely caused by the microaerophilic atmosphere and the elevated concentration of carbon dioxide introduced by the inventive process. The second decrease of 0.76 log could have been caused by a dominance of Lactobacillus bacteria by day 8 on samples stored using the invention, because Lactobacilli produce an antimicrobial agent to inhibit competing microorganisms. A dominance of Lactobacillus bacteria by day 8 seems consistent with the results.

No bacteria were detected on the EMB plates for the samples stored with invention on day 8, and Lactobacilli do not grow on EMB because they are Gram-positive. Changes in meat texture and tenderness were observed in samples by day 6. These changes, which ere likely a result of enzymatic degradation, were most prevalent in samples stored in the plastic bags, and least prevalent in samples stored in activated containers. After processing samples with a tissue homogenizer, lyzates prepared from samples at this time point appeared turbid and extremely viscous. Microbial analysis carried out at this time point indicated that bacterial counts taken from these lyzates were at or near zero. It was speculated that the high viscosity of the lyzates prevented bacterial growth on the surface of the plates, resulting in low bacterial counts. Since high viscosity might have limited bacterial growth on the surface of agar plates, the researcher decided to vortex subsequent meat samples in 0.1% Bactopeptone, rather than homogenize them.

Meat samples kept in plastic bags at day 8, after vortexing, were extremely viscous. This suggests that the samples had undergone significant amounts of enzymatic degradation by this time point. Meat samples kept in non-activated containers still retained some tissue integrity, suggesting that the amount of degradation in these samples was lower than in samples stored in plastic bags. Meat samples stored in activated containers at this time point retained the most tissue integrity, which suggests that enzymatic degradation was lowest in these samples. It can be surmised that the transformed atmospheres slowed the enzymatic degradation in samples stored in activated containers, because certain modified atmospheres have been shown to slow such degradation (Lambert, Smith, & Dodds, 1991). Lyzates prepared from meat samples stored in all three containers were indistinguishable on day 32. This indicates that the inventive process slows enzymatic degradation for a substantial, but not unlimited, length of time.

1. An apparatus for transforming oxygen to carbon dioxide in a container enclosing at least some oxygen, comprising:
means for supporting a carbon material within said container; and
means for applying an electrical current to said carbon material to cause said carbon material to react with oxygen to form carbon dioxide, thereby replacing at least some of the oxygen in said container with carbon dioxide.

2. The apparatus as claimed in claim 1, wherein said container is relatively air tight sufficient to minimize the reentry of oxygen into said container in order to maintain a predominately carbon dioxide environment, whereby food or some other product can be preserved better than if oxygen entered said container easily.

3. The apparatus as claimed in claim 1, wherein said carbon material is in the form of carbon fibers, or carbon rods, and said means for applying an electrical current includes a portion defined to hold and electrically connect to said carbon material.

4. The apparatus as claimed in claim 1, wherein said apparatus includes said container.

5. The apparatus as claimed in claim 1, further including an electrical battery and an electrical circuit capable of applying said battery to said carbon material and also capable of having a predetermined time delay before connecting said battery to said carbon material, and an electrical switch for electrically connecting said battery to said electrical circuit; said apparatus enabling the communication of oxygen within said container with said carbon material, whereby when said carbon material reacts with oxygen, the interior of said container has a substantial increase in carbon dioxide and a substantial decrease in oxygen.

6. A method for replacing oxygen within a container to primarily carbon dioxide, comprising the steps of:
supporting a carbon material within said container; and
providing means to apply an electrical current to said carbon material to cause said carbon material to react with the oxygen to form carbon dioxide.
